(19) United States
(12) Patent Application Publication
(10) Pub. No.: US 2025/0252785 A1
(43) Pub. Date: Aug. 7, 2025

(54) METHOD OF PROVIDING A PARKING SYSTEM USING QR CODE BASED ON ACCURATE RECOGNITION OF LICENSE PLATE

(71) Applicant: LightVision Corp., Seoul (KR)

(72) Inventors: Jin Ha JEONG, Yongin-si (KR); Moon Soo RA, Bucheon-si (KR); Hea Yun LEE, Suwon-si (KR); Hyun Ji LEE, Seoul (KR)

(21) Appl. No.: 19/187,779

(22) Filed: Apr. 23, 2025

Related U.S. Application Data
(63) Continuation of application No. PCT/KR2023/016271, filed on Oct. 19, 2023.

(30) Foreign Application Priority Data
Oct. 27, 2022 (KR) 10-2022-0139914

(51) Int. Cl. G07B 15/02; G06Q 20/10; G06Q 20/32; G06V 10/25; G06V 10/26; G06V 10/70; G06V 20/52; G06V 20/62

(52) U.S. Cl. CPC G07B 15/02; G06Q 20/102; G06Q 20/3276; G06V 10/25; G06V 10/26; G06V 10/70; G06V 20/52; G06V 20/625; G06V 2201/08

(57) ABSTRACT

A method of providing a parking system using QR code based on accurate recognition of a vehicle license plate, more particularly relates to a method of providing the parking system using the QR code, includes a step of accurately recognizing the license plate through a camera installed to a parking lot in snowy and rainy inclement weather, a step of accurately recognizing the license plate when the vehicle's license plate is not clearly visible from the side, a step of accurately recognizing the license plate when the vehicle's license plate is not clearly visible from above or a step of accurately recognizing the license plate when the license plate is mounted on the side of the vehicle and is not properly recognized from the front.

### CROSS-REFERENCE TO RELATED APPLICATIONS

This application is a continuation of pending PCT International Application No. PCT/KR 2023/016271, which was filed on Oct. 19, 2023, and which claims priority under 35 U.S.C 119(a) to Korean Patent Application No. 10-2022-0139914 filed with the Korean Intellectual Property Office on Oct. 27, 2022. The disclosures of the above patent applications are incorporated herein by reference in their entirety.

### TECHNICAL FIELD

The present disclosure relates to a method of providing a parking system using QR code based on accurate recognition of a vehicle license plate, more particularly relates to a method of providing the parking system using the QR code including a step of accurately recognizing the license plate through a camera installed to a parking lot in snowy and rainy inclement weather, a step of accurately recognizing the license plate when the vehicle's license plate is not clearly visible from the side, a step of accurately recognizing the license plate when the vehicle's license plate is not clearly visible from above or a step of accurately recognizing the license plate when the license plate is mounted on the side of the vehicle and is not properly recognized from the front.

### BACKGROUND ART

The issue of insufficient parking areas due to the increasing number of vehicles has been continuously raised. Public parking facilities could serve as a solution, but selecting and securing appropriate land is not easy and incurs high costs. Even if the land is selected and a parking lot is constructed, additional operational expenses such as maintenance, labor costs, and other incidental costs arise. Moreover, if the facility is operated manually, there are limitations on operating hours.

In general, a parking system with a barrier bar requires vehicles to stop when entering and exiting the parking lot. In the case of exit, additional time is needed for payment, resulting in traffic congestion at the exit.

Additionally, for off-street parking lots, a parking attendant had to check the entry time each time, and drivers had to pay the attendant when leaving, resulting in additional time being spent.

When a camera capable of recognizing the vehicle license plate is installed in the parking lot, it may fail to recognize the license plate if rain or snow causes moisture, fogging, or partial obstruction due to snow.

During inclement weather, occlusion causes recognition accuracy to drop of the license plate, and diagonal positioning also decreases the recognition rate. Furthermore, modern cars often have aerodynamic designs that result in wedge-shaped front ends, reducing recognition rates. High-performance vehicles sometimes feature large front air intakes to increase engine airflow and improve brake pad cooling, necessitating side-mounted license plates, which can lead to lower recognition rates using conventional methods.

Accordingly, there is a need for a parking system using QR code that may accurately recognize the license plate even in inclement weather.

### SUMMARY

To solve problems of the conventional technique, the present disclosure is to provide a method of accurately recognizing a license plate through a camera installed in a parking lot in inclement weather, accurately recognizing the license plate from the side or above or accurately recognizing the license plate when the license plate is mounted on the side of the vehicle, by using a machine learning.

A method of providing a parking system using a QR code based on accurate recognition of a license plate, executed by a server according to an embodiment of the present disclosure includes: (a) training a license plate recognition model based on multiple training data including the license plate; (b) receiving an image of a vehicle entering in a parking lot from a camera installed to a parking area and extracting text information of the license plate by inputting the received image to the license plate recognition model; (c) verifying parking area identification information of a parking area on which the vehicle parks when the server receives an image of the parked vehicle; (d) matching user's individual information related to the parked vehicle with the parking area identification information, an entry time and a recognized license plate to complete an entry as a user terminal transmits phone number or information concerning means of payment inputted through a link in QR code installed to the parking area to the server or the server verifies user's identification information stored in association with the recognized license plate; and (e) processing an exit of the vehicle related to the user terminal and performing payment of parking fee based on the information concerning means of payment when an exit signal is received from the user terminal or the license plate of an exited vehicle in the image received from the camera matches with a license plate of an entering vehicle.

The step (a) includes: storing a plurality of training data items; extracting an image region corresponding to the license plate in each of the training data; identifying text of the license plate in the extracted image region; generating refined training data by adding defect images to the extracted image region; and training a preset machine learning model by inputting the refined training data and corresponding texts to the present machine learning model such that the text is outputted when the refined training data is inputted to the preset machine learning model.

The defect image is in arbitrary shape and color, and wherein a size of the defect image is smaller than a size of the extracted image region and the defect image occludes regions of the license plate.

The defect image is in plural shapes and colors, and wherein multiple refined training data corresponding to the license plate are generated.

The defect image is in a shape and a color for simulating snow or rain.

Each of defect images added in the extracted image region has different size at different positions.

The generating the refined training data includes: adding multiple Gaussian-blur masks or multiple white occlusion masks to arbitrary local regions within the extracted image region.

The step (b) includes: (b-1) extracting a license plate region as a polygonal shape by recognizing a boundary of the license plate from the image data captured by the camera; (b-2) transforming coordinates of pixels included in the license plate region so that the polygonal license-plate region is warped into a predetermined rectangular shape; and (b-3) extracting license plate as a text from a license plate region image with transformed coordinates.

The steps (b-1) to (b-3) are performed when the license plate area in the image data captured by the camera is not in a predefined rectangular shape, when the license plate image appears skewed due to the camera being positioned at an acute angle relative to the vehicle from above, below or the sides.

The step (e) further includes: receiving additional identification code concerning current location from the user terminal, or receiving pre-stored location information or current GPS value from the user terminal and providing guidance information for moving to parking location of the vehicle of the user based on current location of the user terminal, in an exit.

A server for providing a parking system using QR code based on accurate recognition of license plate according to an embodiment of the present disclosure includes: a memory configured to store a program about a method of providing a parking service based on the QR code based on accurate recognition of the license plate; and a processor configured to execute the program. Here, the method includes (a) training a license plate recognition model based on multiple training data including the license plate; (b) receiving an image of a vehicle entering in a parking lot from a camera installed to a parking area and extracting text information of the license plate by inputting the received image to the license plate recognition model; (c) verifying parking area identification information of a parking area on which the vehicle parks when the server receives an image of the parked vehicle; (d) matching user's individual information related to the parked vehicle with the parking area identification information, an entry time and a recognized license plate to complete an entry as a user terminal transmits phone number or information concerning means of payment inputted through a link in QR code installed to the parking area to the server or the server verifies user's identification information stored in association with the recognized license plate; and (e) processing an exit of the vehicle related to the user terminal and performing payment of parking fee based on the information concerning means of payment when an exit signal is received from the user terminal or the license plate of an exited vehicle in the image received from the camera matches with a license plate of an entering vehicle.

The step (a) includes: storing a plurality of training data items; extracting an image region corresponding to the license plate in each of the training data; identifying text of the license plate in the extracted image region; generating refined training data by adding defect images to the extracted image region; and training a preset machine learning model by inputting the refined training data and corresponding texts to the present machine learning model such that the text is outputted when the refined training data is inputted to the preset machine learning model.

The defect image is in arbitrary shape and color, and wherein a size of the defect image is smaller than a size of the extracted image region and the defect image occludes regions of the license plate.

The defect image is in plural shapes and colors, and wherein multiple refined training data corresponding to the license plate are generated.

The defect image is in a shape and a color for simulating snow or rain.

Each of defect images added in the extracted image region has different size at different positions.

The generating the refined training data includes: adding multiple Gaussian-blur masks or multiple white occlusion masks to arbitrary local regions within the extracted image region.

The step (b) includes: (b-1) extracting a license plate region as a polygonal shape by recognizing a boundary of the license plate from the image data captured by the camera; (b-2) transforming coordinates of pixels included in the license plate region such that polygonal license plate is transformed to preset rectangular shape; and (b-3) extracting license plate as a text from a license plate region image with transformed coordinates.

The steps (b-1) to (b-3) are performed when the license plate area in the image data captured by the camera is not in a predefined rectangular shape, when the license plate image appears skewed due to the camera being positioned at an acute angle relative to the vehicle from above, below or the sides.

The step (e) further includes:
receiving additional identification code concerning current location from the user terminal, or receiving pre-stored location information or current GPS value from the user terminal and providing guidance information for moving to parking location of the vehicle of the user based on current location of the user terminal, in an exit.

A method of the present disclosure may recognize a license plate through a camera under severe weather conditions including heavy rain and snow, or even if the license plate is mounted to the side not the top and the front, by using machine learning obtained by polygon-based license plate detection followed by coordinate transformation.

### BRIEF DESCRIPTION OF DRAWINGS

Example embodiments of the present disclosure will become more apparent by describing in detail example embodiments of the present disclosure with reference to the accompanying drawings, in which:

FIG. 1 is a view illustrating an AI-based parking system using QR code according to an embodiment of the present disclosure;

FIG. 2 is a view illustrating a server according to an embodiment of the present disclosure;

FIG. 3 is a view illustrating an AI-based parking system using QR code of a parking lot with installed camera according to another embodiment of the present disclosure;

FIG. 4 is a diagram illustrating operational flow of an Al-based parking system using QR code according to an embodiment of the present disclosure;

FIG. 5 is a flowchart illustrating operation of an Al-based parking system using QR code according to an embodiment of the present disclosure;

FIG. 6 is a view illustrating an example of entry, exit and payment process in the AI-based parking system according to an embodiment of the present disclosure;

FIG. 7 is view illustrating an example of QR code used in an AI-based parking system using the QR code according to an embodiment of the present disclosure;

FIG. 8 is a view illustrating an entry process of an AI-based parking system using QR code according to an embodiment of the present disclosure;
(A) of FIG. 9 is a view illustrating an example of recognition of additional identification code adhered to a parking lot by a user terminal according to an embodiment of the present disclosure;
(B) of FIG. 9 is a view illustrating an example of guidance information for exit in an AI-based parking system using QR code according to an embodiment of the present disclosure;

FIG. 10 is a view illustrating an exit process of an AI-based parking system using QR code according to an embodiment of the present disclosure;

FIG. 11 is a flowchart illustrating operation of an AI-based parking system using QR code of a parking lot with installed camera according to another embodiment of the present disclosure;

FIG. 12 is a view illustrating an example of entry, exit and payment process in an AI-based parking system using QR code in a parking lot in which a camera is installed according to a second embodiment of the present disclosure;

FIG. 13 is a view illustrating an example of search of a parking lot and guidance of vacant parking area in an Al-based parking system using QR code of a parking lot with installed camera according to another embodiment of the present disclosure;

FIG. 14 is a view illustrating an application of an Al-based parking system using QR code according to an embodiment of the present disclosure;

FIG. 15 is a flowchart illustrating a process of performing machine learning to recognize license plate through a camera in inclement weather according to another embodiment of the present disclosure;

FIG. 16 is a view illustrating a process of collecting the image data including the license plate through the camera and extracting the image about the license plate area according to another embodiment of the present disclosure;

FIG. 17 is a view illustrating an example of a defect image for snowy or rainy weather in a method of providing a parking system based on QR code based on accurate recognition of a license plate according to another embodiment of the present disclosure;

FIG. 18 is a flowchart illustrating a process of obtaining a license plate image through a side image or an above image in a method of providing a parking system based on QR code based on accurate recognition of a license plate according to another embodiment of the present disclosure;

FIG. 19 is a view illustrating an example of recognition of a license plate captured in left side and right side in a method of providing a parking system based on QR code based on accurate recognition of a license plate according to another embodiment of the present disclosure;

FIG. 20 is a view illustrating an example of an image when capturing a license plate at an upper side of a front side of a vehicle in a method of providing a parking system based on QR code based on accurate recognition of a license plate according to another embodiment of the present disclosure; and

FIG. 21 is a view illustrating a vehicle with a license plate located on the side according to still another embodiment of the present disclosure.

### DETAILED DESCRIPTION

Example embodiments of the present invention are disclosed herein with reference to accompanying drawings. However, specific structural and functional details disclosed herein are merely representative for purposes of describing example embodiments of the present invention, however, example embodiments of the present invention may be embodied in many alternate forms and should not be construed as limited to example embodiments of the present invention set forth herein. Like numbers refer to like elements throughout the description.

It will be understood that when an element is referred to as being “connected” or “coupled” to another element, it can be directly connected or electrically coupled to the other element or intervening elements may be present. Additionally, when it is stated that a particular part “includes” certain components, unless otherwise specified, this means that other components may also be included in addition to those mentioned.

In this specification, the term ‘unit’ encompasses units realized by hardware, units realized by software, and units realized by both hardware and software. Additionally, one unit may be implemented using more than one piece of hardware, and multiple units may be implemented using a single piece of hardware. The term ‘˜unit’ does not limit itself to software or hardware; it can also be structured to reside in addressable storage media and may be configured to be executed by one or more processors. Therefore, as an example, ‘˜unit’ includes software components such as objects, object-oriented software components, classes, tasks, functions, procedures, subroutines, segments of program code, drivers, firmware, microcode, circuits, data, databases, data structures, tables, arrays, and variables. The functions provided within the units and components can be combined into smaller numbers of components and units or further separated into additional components and units. Furthermore, the components and units may be implemented to be executed by one or more CPUs within a device or secure multimedia card.

Hereinafter, the “user terminal” referred to is a computer or portable terminal that can access servers or other terminals via a network. A computer, in this context, may include laptops, desktops, and VR HMDs equipped with web browsers, such as HTC VIVE, Oculus Rift, GearVR, DayDream, and PSVR. This encompasses both PC-based VR HMDs (e.g., HTC VIVE, Oculus Rift, FOVE, Deepon) and mobile-based ones (e.g., GearVR, DayDream, google's card-board), as well as standalone models (e.g., Deepon, PICO). Portable terminals refer to wireless communication devices that ensure portability and mobility, including smartphones, tablet PCs, wearable devices, and various devices equipped with communication modules like Bluetooth (BLE), NFC, RFID, ultrasonic, infrared, WiFi, and LiFi. The term “network” refers to a structure that allows information exchange between nodes such as terminals and servers, encompassing LAN (Local Area Network), WAN (Wide Area Network), the Internet (WWW), wired and wireless data communication networks, telephone networks, and wired and wireless television communication networks. Examples of wireless data communication networks include 3G, 4G, 5G, 3GPP (3rd Generation Partnership Project), LTE (Long Term Evolution), WIMAX (Worldwide Interoperability for Microwave Access), WiFi, Bluetooth communication, infrared communication, ultrasonic communication, VLC (Visible Light Communication), and LiFi, but are not limited to these.

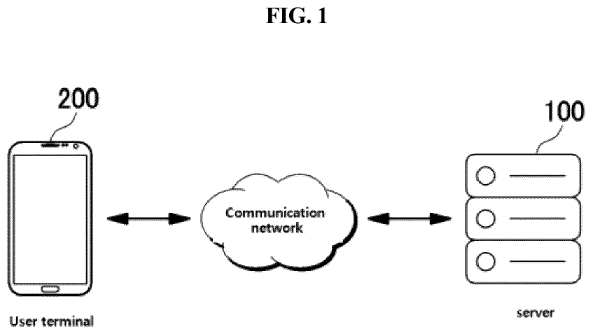

Hereinafter, a system according to an embodiment of the present disclosure will be described with reference to a drawing FIG. 1.

In FIG. 1, a system of the present embodiment includes a server 100 and a user terminal 200.

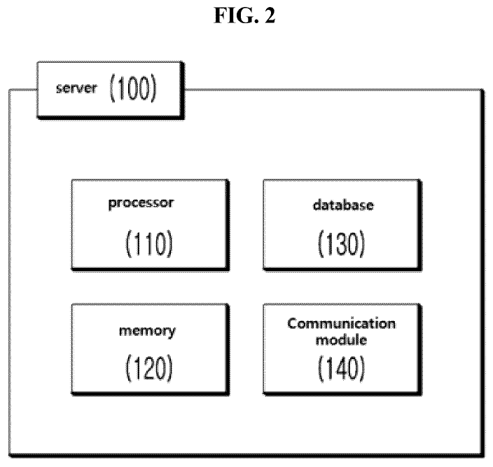

The server 100 will be described with reference to accompanying a drawing FIG. 2. In FIG. 2, the server 100 includes a processor 110, a memory 120, a database 130 and a communication module 140.

The processor 110 executes a parking program stored in the memory 120 such that the user terminal 200 performs entry, exit and payment processes. The database 130 stores parking information inputted through the user terminal 200 when a vehicle enters, wherein the parking information includes portable phone number, license plate or encrypted payment card information. The communication module 140 communicates with the user terminal 200 to provide a parking system when the user terminal 200 accesses a parking application or a parking webpage to receive an AI (artificial intelligence)-based parking system.

The user terminal 200 accesses the parking application or the parking webpage by photographing QR code provided in a parking lot and performs entry, exit and fee payment through the parking application or the parking webpage.

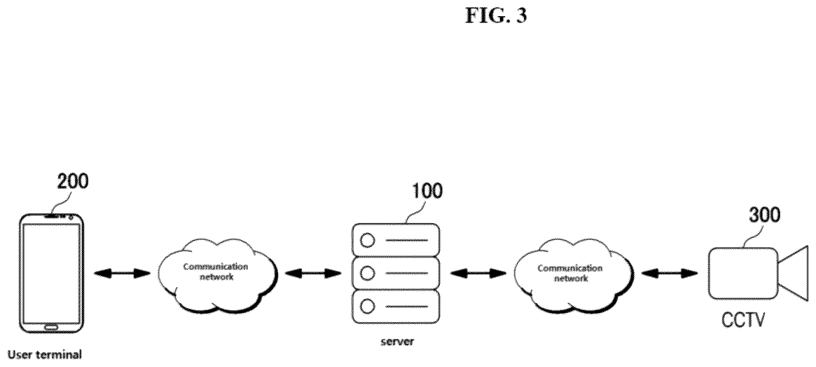

Hereinafter, the AI-based parking system using the QR code of the parking lot where a parking camera is installed according to a second embodiment of the present disclosure will be described with reference to a drawing FIG. 3.

In FIG. 3, the parking system of the present embodiment includes the server 100, the user terminal 200 and a CCTV 300.

The CCTV 300 can also be referred to as a camera, constantly monitor the parking lot, and transmit vacant parking areas, the identification information and location of the vacant parking areas in the parking lot to the server 100. When a vehicle arrives at the parking lot and enters the vacant parking area, the CCTV 300 may recognize license plate and an entry time and transmit the recognized license plate and entry time to the server 100. Next, when the vehicle leaves the parking area, the CCTV 300 may recognize the license plate and an exit time and transmit the recognized license plate and exit time to the server 100.

In this case, the CCTV 300 may transmit information concerning the location of the parking area to the user terminal 200 such that the information is represented on a map.

The descriptions of the server 100 and the user terminal 200 will be based on the content explained in FIG. 1. Hereinafter, we will focus on explaining the content not mentioned in FIG. 1.

The server 100 may provide various information of the parking lot transmitted from the camera according to request of an application of the user terminal 200. This will be described in detail with reference to following drawing FIG. 9.

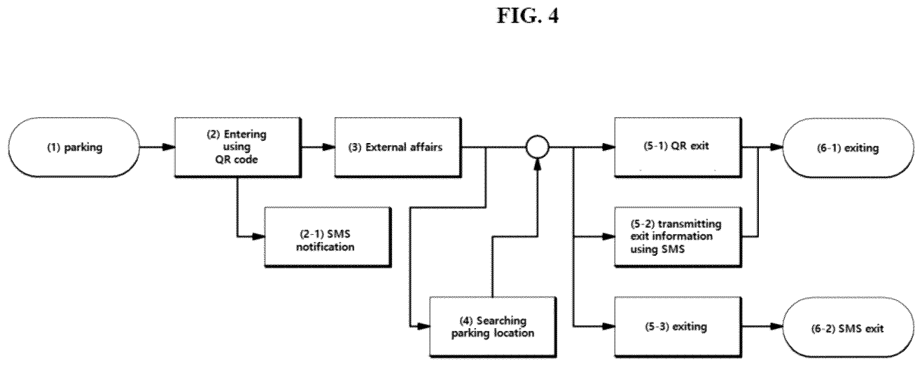

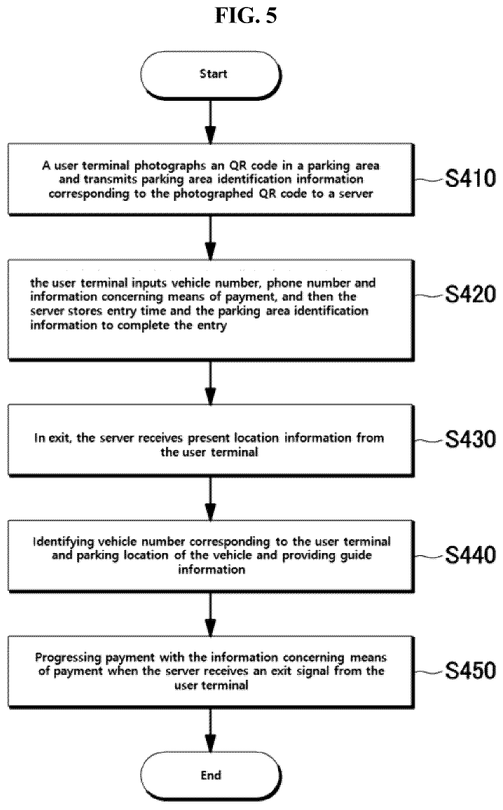

Hereinafter, operational flow of the AI-based parking system using the QR code according to an embodiment of the present disclosure will be described with reference to a drawing FIG. 4.

If a vehicle enters using QR code in a parking lot in a step of 1 and a step of 2, SMS notification is received in a step of 2-1, and a user performs external affairs in a step of 3. The user searches parking location for exit when the user returns in a step of 4, the exit is performed through by transmitting QR photographing in a step of 5-1, is performed by transmitting exit information using SMS in a step of 5-2, or is performed by leaving the parking lot in a step of 5-3. In the steps of 5-1 and 5-2, the server processes the exiting. In the step of 5-3, the camera in the parking lot recognizes the exited vehicle and processes automatically the exiting. In a step of 6-2, exiting complete information may be transmitted to the user terminal through SMS.

Hereinafter, general description of the present disclosure will be described in detail with reference to accompanying drawings.

An AI-based parking system using QR code in a large-area parking lot where a barrier bar and a camera don't exist will be described in detail with reference to accompanying drawing FIG. 5.

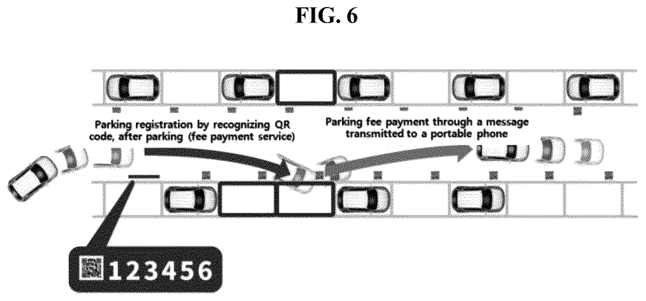

FIG. 6 shows an example of entry, exit and payment process in the AI-based parking system.

In a step of S410, the user terminal 200 photographs QR code in a parking area and transmits parking area identification information corresponding to the photographed QR code to the server 100. In a step of S420, the user terminal 200 inputs license plate, phone number and information concerning means of payment, and then the server 100 stores an entry time and the parking area identification information to complete the entry.

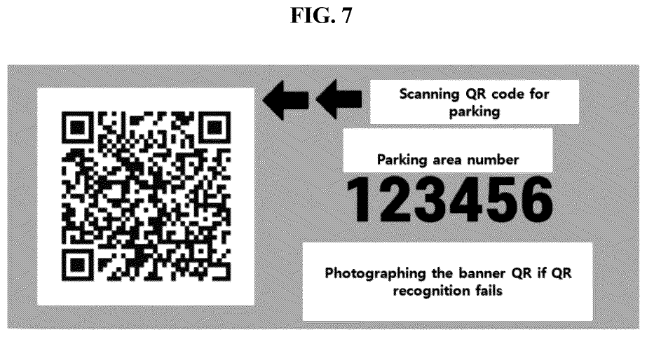

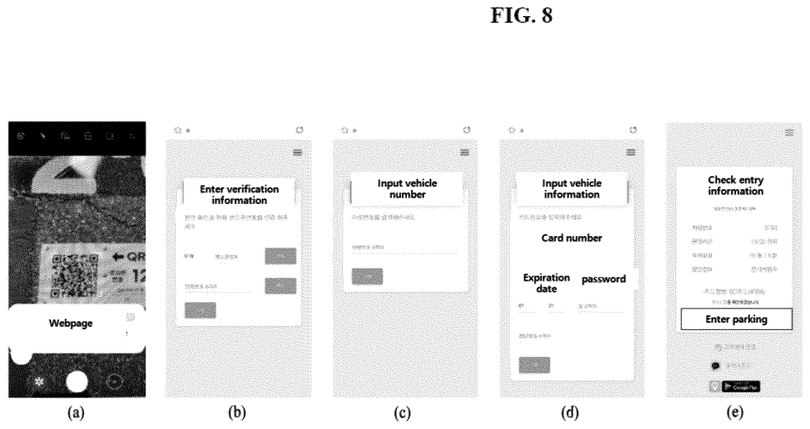

Hereinafter, a detailed process in the steps of S410 and S420 will be described with reference to accompanying drawings FIG. 7 to FIG. 8.

FIG. 7 is view illustrating an example of QR code used in an AI-based parking system using the QR code according to an embodiment of the present disclosure.

In the large-area parking lot where the barrier bar is not installed at a parking entrance and the camera does not exist, a vehicle enters in vacant parking area in the parking lot and then a driver photographs QR code shown on a ground or a wall of the parking lot using the user terminal 200. The QR code includes the parking area identification information, and the user terminal 200 transmits the parking area identification information corresponding to the photographed QR code to the server 100.

FIG. 8 is a view illustrating an entry process of an AI-based parking system using QR code according to an embodiment of the present disclosure.

In the step of S410, in the event that the user terminal 200 transmits the parking area identification information corresponding to the QR code to the server 100, the server 100 transmits URL address accessing to a webpage to the user terminal 200 such that the URL address is shown on an area of the user terminal 200. The user terminal 200 accesses to the webpage by inputting the URL address transmitted from the server 100.

If the access to the webpage is completed, a screen shown in (b) in FIG. 8 is displayed. The user terminal 200 requests verification code to the server 100 after inputting phone number, receives the verification code from the server 100 and inputs the received verification code.

If the inputting of the phone number and the verification code is completed, a screen for inputting license plate is displayed as shown in (c) in FIG. 8, and the user terminal 200 inputs the last four digits or whole of the license plate.

If the inputting of the license plate is completed, a screen for inputting information concerning means of payment is displayed as shown in (d) in FIG. 8, and the user terminal 200 inputs card number, expiration date, the first two digits of the password and date of birth.

If the inputting of the information concerning means of payment is completed, a final step for entry starts, the entry is completed when the user selects “enter parking” and the information concerning means of payment is stored and matched with entry time and parking area identification information.

In a step of S440, in exit, the server 100 receives current location information from the user terminal 200. In a step of S440, the server 100 identifies the license plate corresponding to the user terminal 200 and parking location of the vehicle and provides guidance information.

The step of S430 will be described with reference to accompanying drawing (A) of FIG. 9. In (A) of FIG. 9, each parking spot has a printed label attached, which comprises an additional identification code including information about its current location within the parking lot. The server 100 transmits information concerning current location to the user terminal 200 when the user terminal 200 recognizes the additional identification code and transmits the recognized additional identification code to the server 100. Or, the user terminal 200 transmits its GPS value to the server 100. The server 100 identifies the license plate corresponding to the user terminal 200 and the parking location of the vehicle and then provides the guidance information. The guidance information is provided in three different ways.

In a first way, the server 100 displays the current location, the parking location and moving path on a parking map and provides the displayed map to the user terminal 200. The server 100 provides a parking layout, displays current location of the user terminal 200 and the parking location of the vehicle corresponding to the user terminal 200 on the parking layout and displays a moving path from the current location to the parking location as a line on the parking layout. The user terminal 200 displays its current location on the moving path by using at least one of a GPS, an accelerometer and a gyroscope.

A second way and a third way will be described with reference to accompanying drawing (B) of FIG. 9.

(B) of FIG. 9 is a view illustrating an example of guidance information for exit in an Al-based parking system using QR code according to an embodiment of the present disclosure.

In the second way, the user terminal 200 shows a moving path through an AR image while the user terminal 200 is in camera mode. The moving path is shown using an arrow in the AR image on the screen while the user terminal 200 is in the camera mode as shown in (a) in (B) of FIG. 9, and the driver moves along the arrow shown on the user terminal 200. In this time, the user terminal 200 may display next directional arrow for the moving path by using at least one of the GPS, the accelerometer and the gyroscope.

In the third way, the user terminal 200 displays the moving path through the AR image while the user terminal 200 is in the camera mode, wherein identification information for parking location is displayed in only a direction of the parking location on the AR image. The driver may move in a direction in which corresponding AR image is continuously displayed to reach the parking area when the AR image is viewed through a 360-degree rotation on the user terminal 200.

In the event that the user terminal 200 is in camera mode and is rotated 360 degrees, identification information for the parking location is displayed in the direction corresponding to the parking area on a portion of the user terminal 200 as shown in (b) in (B) of FIG. 9. The driver refers to the identification information displayed on the user terminal 200 and moves in the indicated direction to reach the parking area.

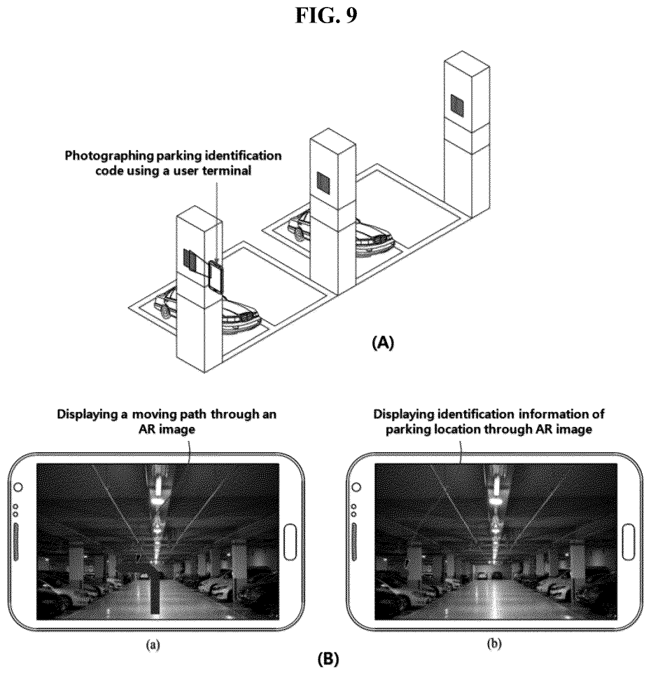

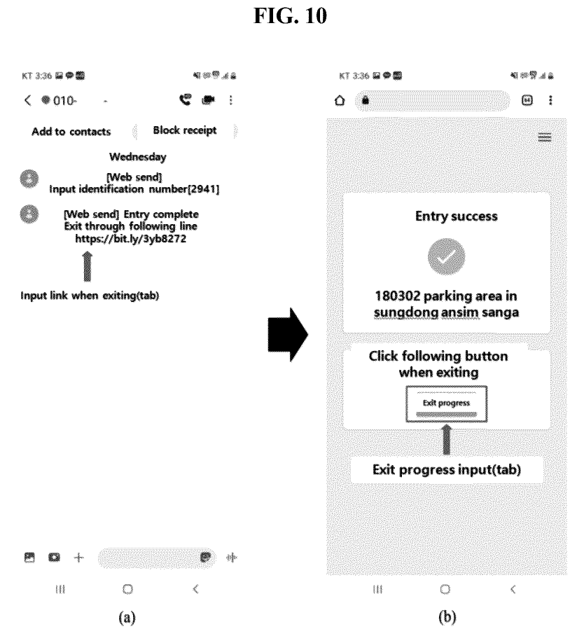

In a step of S450, the server 100 proceeds payment with the information concerning means of payment when it receives an exit signal from the user terminal 200. The server 100 performs the payment process for exit when the driver reaches the parking area at which the vehicle parks through the step of S440. This will be described with reference to accompanying drawing FIG. 10.

(a) in FIG. 10 shows a screen of exit URL provided as a message when the entry is completed in the step of S420. The screen is shifted to an exit page as shown in (b) in FIG. 10 when URL link is selected for the exit, an entry success message is displayed on the screen, and the payment is performed with the information concerning means of payment inputted in the step of S420 when exit progress displayed on the screen is inputted through tab.

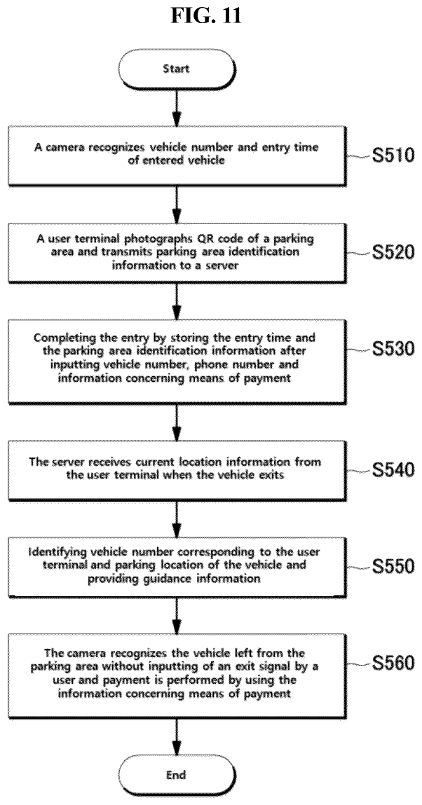

Hereinafter, an operation of an AI-based parking system using QR code in a resident priority parking area in which a barrier bar does not exit but a camera is installed will be described in detail with reference to a drawing FIG. 11.

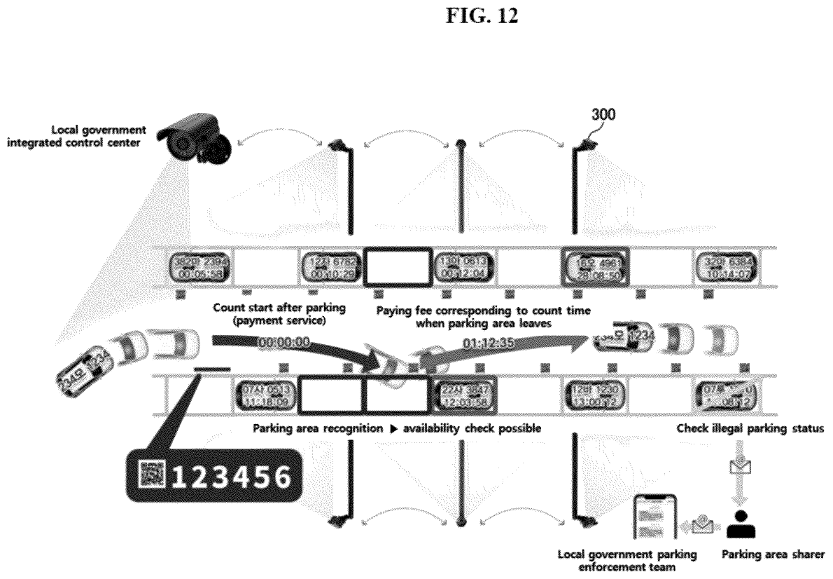

FIG. 12 shows an example of entry, exit and payment process in an AI-based parking system using QR code in a parking lot in which a camera is installed according to a second embodiment of the present disclosure.

In a step of S510, a camera recognizes license plate and an entry time of entered vehicle.

A camera employed in local government or government office is installed in a resident priority parking area where a barrier bar is not installed at an entrance. The camera may photograph the parking lot 24 hours a day for security monitoring. Here, in the event that a vehicle reaches the parking lot, the camera installed in the parking lot may recognize license plate and an entry time of the vehicle entering in vacant parking area.

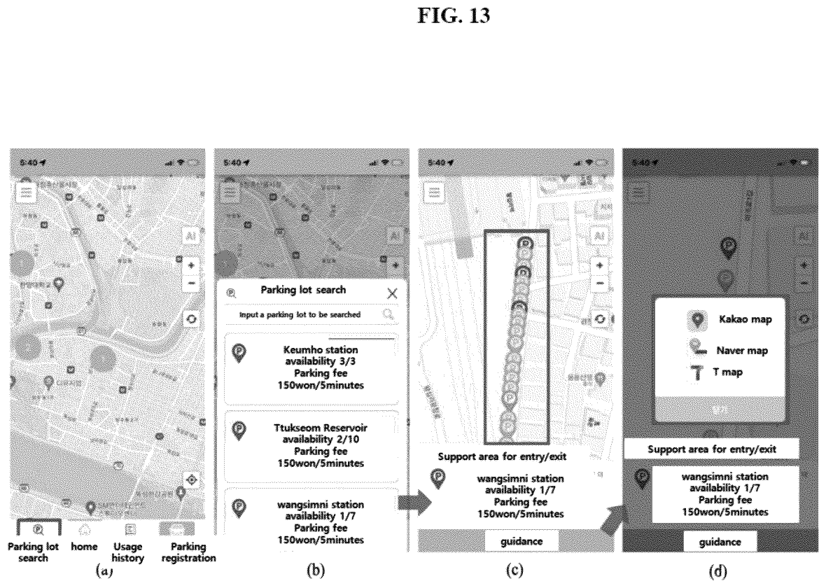

In another embodiment, in the event that an application is installed to the user terminal 200, a user may check location of the parking lot and whether or not vacant parking area exists through the application before the step of S510 and receive a moving path from current location of the vehicle to the parking lot. This will be described with reference to accompanying a drawing FIG. 13.

Referring to FIG. 13, the parking system according to a second embodiment of the present disclosure may explain how to locate the parking lot and guide the user to an available parking area before entering the Al-powered parking lot, which utilizes a QR code and is equipped with parking cameras.

(a) in FIG. 13 shows number of available parking area displayed on a map of an application, and the user may search the parking lot through a parking lot search displayed in a lower region.

Referring to (b) in FIG. 13, the user may verify a parking lot list corresponding to input of the parking lot search by the user terminal 200. The list includes name, address, indoor or outdoor, operating hours, parking fee, total available number of vehicles and current available number of vehicles, for the parking lot.

In the event that the user terminal 200 selects the available number, a parking area of corresponding parking lot may be displayed on the user terminal 200 as shown in (c) in FIG. 13, and the user may check vacant parking area, identification information of the vacant parking area and location of the vacant parking area through a camera. The server 100 may display information concerning the location of the vacant parking area on the map and provide the map on which the information is displayed to the user terminal 200.

In the event that the user terminal 200 selects guidance located on its lower portion in (c) in FIG. 13, the user may get a service for providing a path guidance from current location of the user terminal 200 to the vacant parking area as shown in (d) in FIG. 13. The user terminal 200 receives the path guidance by selecting the service preset to the user terminal 200 of plural services.

In a step of S520, the user terminal 200 photographs QR code of the parking area and transmits parking area identification information to the server 100. In a step of S530, the entry is completed by storing the entry time and the parking area identification information after inputting license plate, phone number and information concerning means of payment. In a step of S540, in exit, the server 100 receives current location information from the user terminal 200. In a step of S550, the server 100 identifies license plate corresponding to the user terminal 200 and parking location of the vehicle and provides guidance information.

The steps of S520 to S550 are replaced with the steps of S410 to S440 in FIG. 5. In a step of S560, the camera recognizes the vehicle left from the parking area without inputting of an exit signal by a user and payment is performed by using the information concerning means of payment.

The camera recognizes the identification information of the vehicle when a driver reaches the parking area and leaves the parking area without inputting extra exit signal and obtains an exit time of the vehicle. The server 100 verifies license plate corresponding to license plate of the exited vehicle of license plates pre-stored in the step S510 and the entry time when the camera transmits the recognized license plate and the exit time, and calculates a parking time based on the entry time and the exit time. The server 100 proceeds automatically the payment by using the information concerning means of payment pre-inputted in the step S530.

The server 100 may transmit a payment completion message to the phone number inputted in the step S530 when the payment is automatically performed.

A process in the AI-based parking system using the QR code in a large-area parking lot where the barrier bar does not exist and but the camera exists according to a third embodiment of the present disclosure is the same as in the process in the second embodiment.

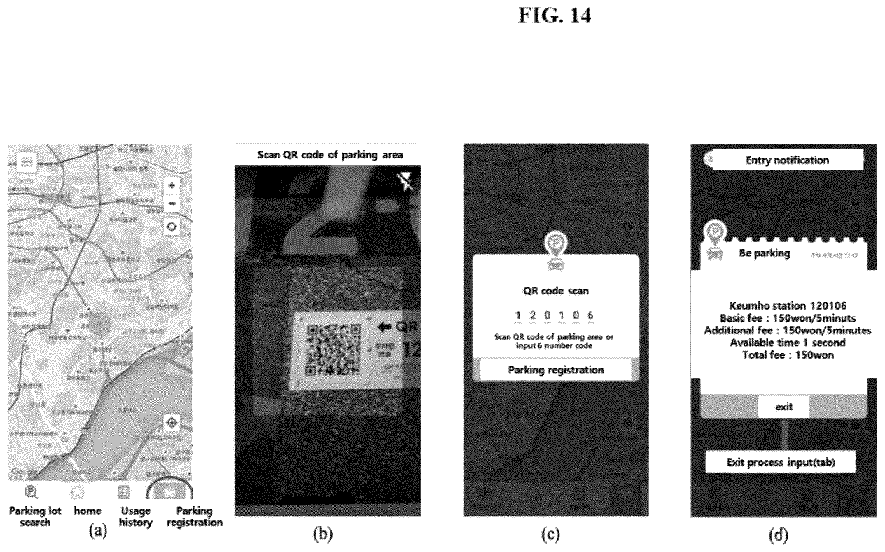

In still another embodiment, in the event that an application is installed to the user terminal 200, the entry may be performed without performing the step S420 in FIG. 5 and the step S530 in FIG. 11 when license plate, phone number and information concerning means of payment are pre-stored in the application. This will be described with reference to accompanying a drawing FIG. 14.

FIG. 14 is a view illustrating an application of an Al-based parking system using QR code according to an embodiment of the present disclosure.

A user locates a vehicle in a parking area, executes the application of the user terminal 200, selects a parking registration displayed on a portion of the application as shown in (a) in FIG. 14, and identifies the QR code using the user terminal 200 as shown in (b) in FIG. 14. An entry is completed as shown in (d) in FIG. 14 when the user checks a number of the parking area provided from the application and selects the parking registration as shown in (c) in FIG. 14. Here, license plate, phone number and information concerning means of payment are pre-stored in installed application, and thus it is not necessary to input them through an extra process.

In another embodiment, in the event that a controller of a vehicle and the user terminal 200 are connected via a local area network and a rearview camera image is displayed on a center fascia screen as the vehicle performs reverse parking. In the event that an image including QR code of the rearview camera images is detected, the vehicle transmits the image including the QR code to the user terminal 200. The user terminal 200 may extract the QR code from the image transmitted from the vehicle, access automatically to a related link, and transmit parking area identification information included in the QR code and phone number of the user terminal 200 to the server 100. As a result, a driver may complete the entry without extra action.

In still another embodiment, in the event that the controller of the vehicle and the user terminal 200 are connected via a local area network and the rearview camera image is displayed on the center fascia screen as the vehicle performs reverse parking. In the event that an image including QR code of the rearview camera images is detected, the user photographs the image through the user terminal 200. The user terminal 200 may access to a link related to the QR code in the image photographed by the user terminal 200 and transmit the parking area identification information included in the QR code and the phone number of the user terminal 200 to the server 100.

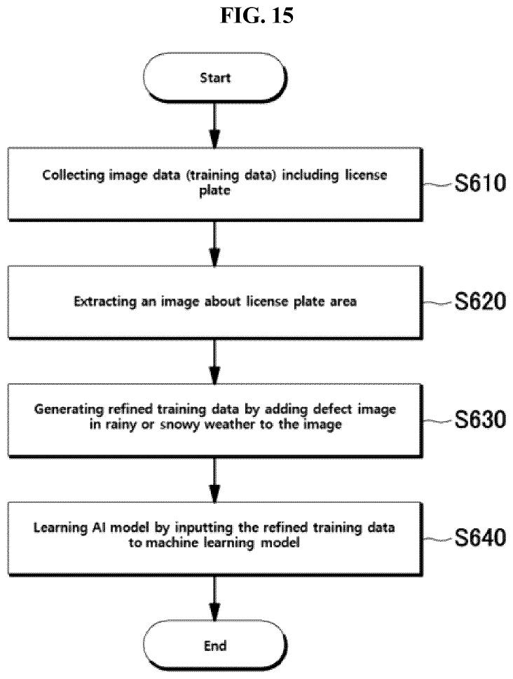

In still another embodiment, the camera may recognize the license plate through machine learning in inclement weather. This will be described in detail with reference to accompanying drawing FIG. 15.

FIG. 15 is a flowchart illustrating a process of performing machine learning to recognize license plate through a camera in inclement weather according to another embodiment of the present disclosure.

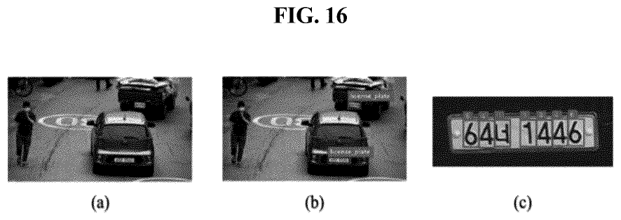

An image data (training data) including a license plate is collected in a step of S610, and an image about license plate area is extracted in a step of S620. The steps S610 and S620 will be described with reference to accompanying a drawing FIG. 16. FIG. 16 is a view illustrating a process of collecting the image data including the license plate through the camera and extracting the image about the license plate area. The camera may detect location of the license plate in the vehicle as shown in (b) in FIG. 16 when the vehicle passes as shown in (a) in FIG. 16. The camera may distinguish and recognize individual numbers and letters within the license plate area, extract the corresponding images, and identify the full license plate by combining the recognized numbers and letters, as shown in (c) in FIG. 16.

In a step of S630, the camera generates refined training data by adding defect image in rainy or snowy weather to the image. Since there are limitations in obtaining defect images under actual rainy or snowy weather, the camera may place individual defect images with different sizes at different positions within the extracted image area

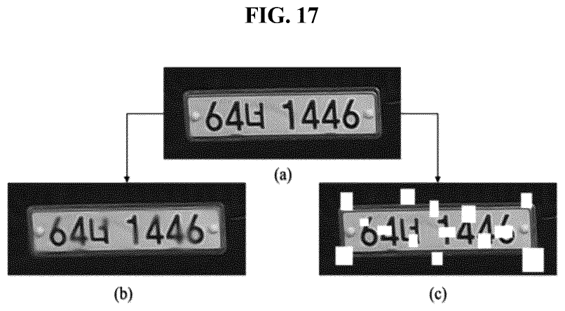

Referring to FIG. 17, raindrops may be simulated by partially applying a blind effect as shown in (b) in FIG. 17 to a normal license plate shown in (a) in FIG. 17. Heavy snowfall may be simulated by arbitrarily placing white rectangular-shaped defects in specific regions of the license plate image as shown in (c) in FIG. 17. However, the form of the artificially added defects is not limited to the aforementioned example.

Size of the defect image is smaller than that of the extracted image area, and thus the defect images blinds regions of the license plate. Multiple refined training data corresponding to one license plate may be generated when the defect image has plural shapes and colors.

In a step of S640, an AI model is trained by inputting the refined training data to a machine learning model. Incorporating simple defects into the refined training data enables the Al model to recognize accurately the license plate even when numbers (or characters) are partially occluded, rather than only when they are fully visible. Furthermore, due to the simplicity of the defects, there is no significant increase in training time.

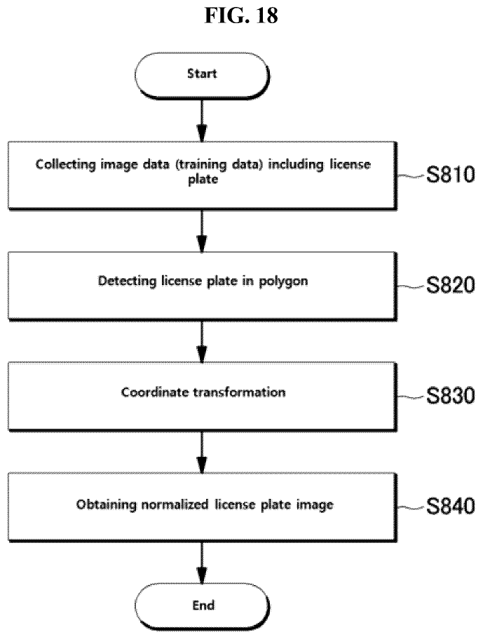

Referring to FIG. 18, a further embodiment of the present disclosure will be described, which relates to an algorithm capable of accurately recognizing numbers of the license plate even when the image is captured at a low angle and the license plate appears non-standard.

In a step of S810, the algorithm collects image data (training data) including the license plate.

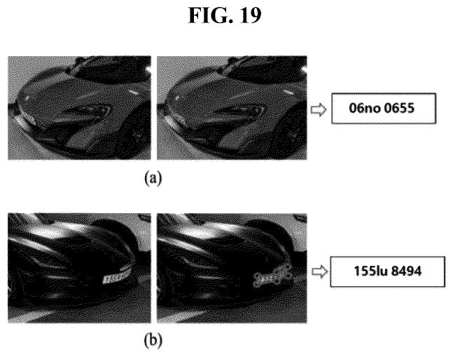

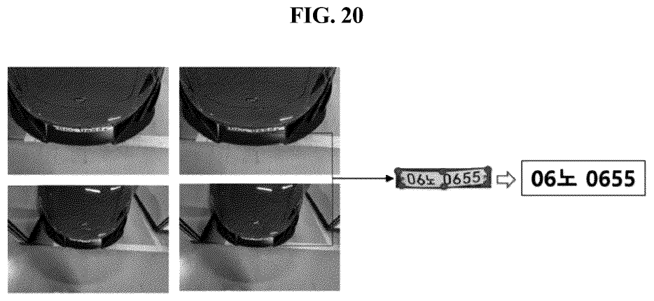

In a step of S820, the algorithm detects the license plate in polygon. Particularly, in FIG. 19 and FIG. 20, the algorithm may identify a region corresponding to the license plate from the image data based on color and extract a feature point (or apex, corner, etc.) to detect the region in polygon.

In a step of S830, the algorithm performs a coordinate transformation. Particularly, the detected region is often captured from an angle-either from the sides or from above-resulting in a skewed image that does not exhibit the typical rectangular shape seen when viewed head-on. In some cases, the license plate itself may be bent, further deviating from the standard rectangular form. Hence, in order to accurately identify the characters within the license plate, it is necessary to transform the detected region into a rectangular shape. This is achieved through a coordinate transformation process. Specifically, the coordinate of a feature point (apex or corner) of the polygonal region of the license plate are first identified. Then, by computing how each of these coordinates should be corrected to form a rectangle, the coordinate transformation is completed. During this process, all pixel values within the region of the license plate are transformed.

In a step of S840, the algorithm may obtain a license plate image normalized in a rectangular shape. Accordingly, the algorithm may extract the license plate image with clearly defined characters as shown in FIG. 19 to FIG. 20.

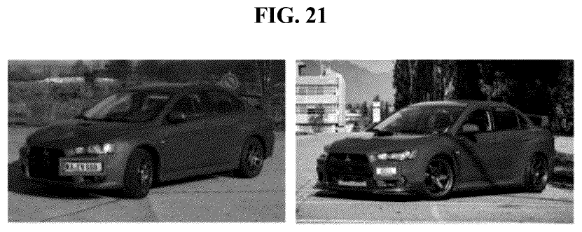

FIG. 21 is a view illustrating a vehicle with a license plate located on the side according to still another embodiment of the present disclosure. Referring to FIG. 21, it can be seen that the license plate, which is located on one side rather than the center of the front of the vehicle, is marked with a blue boundary. In this case, the license plate captured from the front of the vehicle may be recognized in a polygonal shape, as shown in FIG. 19 to FIG. 20. Through the steps S810 to S840, a normalized license plate image may be obtained

The technical features described above can be implemented in the form of program instructions that may be performed using various computer means and can be recorded in a computer-readable medium. A computer-readable medium may be any available medium that can be accessed by a computer, and includes both volatile and non-volatile media, as well as removable and non-removable media. The computer-readable medium may include all forms of computer storage media. Computer storage media include all volatile and non-volatile, removable and non-removable media implemented in any method or technology for the storage of information such as computer-readable instructions, data structures, program modules, or other data.

The method and system of the present disclosure have been described in connection with certain embodiments; however, some or all of their components or operations may be implemented using a computer system with general-purpose hardware architecture.

The above description of the present disclosure is intended as illustrative, and it will be understood by those skilled in the art that various modifications can be made in specific forms without departing from the spirit or essential features of the disclosure. Therefore, the embodiments described above should be understood as illustrative rather than limiting in every respect. For example, each component described as being implemented in a singular form may be implemented in a distributed manner, and likewise, components described as being distributed may also be implemented in a combined form.

The scope of the present disclosure is defined not by the foregoing detailed description but by the following claims, and all modifications or variations derived from the meaning and scope of the claims and their equivalents should be interpreted as being included within the scope of the disclosure.

1. A method of providing a parking system using QR code based on recognition of a license plate, executed by a server, the method comprising the steps of:
(a) training a license plate recognition model based on multiple training data including the license plate;
(b) receiving an image of a vehicle entering in a parking lot from a camera installed to a parking area and extracting text information of the license plate by inputting the received image to the license plate recognition model;
(c) verifying parking area identification information of a parking area on which the vehicle parks when the server receives an image of the parked vehicle;
(d) completing entry by associating the parking area identification information, entry time, and recognized license plate with user profile including phone number and payment method received via a QR-code link, or, when pre-registered, by automatically retrieving the user profile linked to the recognized license plate; and
(e) processing an exit of the vehicle related to the user profile and performing payment of parking fee based on the payment method when an exit signal is received from a user terminal or a license plate of an exited vehicle in the image received from the camera matches with the license plate of the vehicle related to the user profile.

2. The method of claim 1, wherein the step (a) includes:
storing a plurality of training data;
extracting an image region corresponding to the license plate in each of the training data;
identifying text of the license plate in the extracted image region;
generating refined training data by adding defect images to the extracted image region; and
training a preset machine learning model by inputting the refined training data and corresponding texts to the preset machine learning model such that the text is outputted when the refined training data is inputted to the preset machine learning model.

3. The method of claim 2, wherein a defect image is in arbitrary shape and color,
and wherein a size of the defect image is smaller than a size of the extracted image region and the defect image occludes regions of the license plate.

4. The method of claim 3, wherein the defect image is in plural shapes and colors,
and wherein multiple refined training data corresponding to the license plate are generated.

5. The method of claim 3, wherein the defect image is in a shape and a color for simulating snow or rain.

6. The method of claim 3, wherein each of the defect images added in the extracted image region has different size at different positions.

7. The method of claim 3, wherein the generating the refined training data includes:
adding multiple Gaussian-blur masks or multiple white occlusion masks to arbitrary local regions within the extracted image region.

8. The method of claim 1, wherein the step (b) includes the steps of:
(b-1) extracting a license plate region as a polygonal shape by recognizing a boundary of the license plate from the image captured by the camera;
(b-2) transforming coordinates of pixels included in the license plate region such that the polygonal shape is transformed to preset rectangular shape; and
(b-3) extracting the text information from the license plate region with transformed coordinates.

9. The method of claim 8, wherein the steps (b-1) to (b-3) are performed when the license plate region in the image captured by the camera is not in a predefined rectangular shape, or when the license plate region appears skewed due to the camera being positioned at an acute angle relative to the vehicle from above, below or sides.

10. The method of claim 1, wherein the step (e) further includes:
receiving additional identification information concerning current location from the user terminal, or receiving pre-stored location information or current GPS value from the user terminal and providing guidance information to parking location of the vehicle based on current location of the user terminal, in the exit of the vehicle.

11. A server for providing a parking system using QR code based on recognition of license plate, the server comprising:
a memory configured to store a program about a method of providing a parking service using the QR code based on the recognition of the license plate; and
a processor configured to execute the program,
wherein the method includes the steps of:
(a) training a license plate recognition model based on multiple training data including the license plate;
(b) receiving an image of a vehicle entering in a parking lot from a camera installed to a parking area and extracting text information of the license plate by inputting the received image to the license plate recognition model;
(c) verifying parking area identification information of a parking area on which the vehicle parks when the server receives an image of the parked vehicle;
(d) matching user's individual information related to the parked vehicle with the parking area identification information, an entry time and a recognized license plate to complete an entry as a user terminal transmits phone number or information concerning means of payment inputted through a link in the QR code installed to the parking area to the server or the server verifies user's identification information stored in association with the recognized license plate; and
(e) processing an exit of the vehicle related to the user terminal and performing payment of parking fee based on the information concerning means of payment when an exit signal is received from the user terminal or a license plate of an exited vehicle in the image received from the camera matches with the license plate of the vehicle related to the user terminal.

12. The server of claim 11, wherein the step (a) includes:
storing a plurality of training data;
extracting an image region corresponding to the license plate in each of the training data;
identifying text of the license plate in the extracted image region;
generating refined training data by adding defect images to the extracted image region; and
training a preset machine learning model by inputting the refined training data and corresponding texts to the preset machine learning model such that the text is outputted when the refined training data is inputted to the preset machine learning model.

13. The server of claim 12, wherein a defect image is in arbitrary shape and color,
and wherein a size of the defect image is smaller than a size of the extracted image region and the defect image occludes regions of the license plate.

14. The server of claim 12, wherein the defect image is in plural shapes and colors,
and wherein multiple refined training data corresponding to the license plate are generated.

15. The server of claim 12, wherein the defect image is in a shape and a color for simulating snow or rain.

16. The server of claim 12, wherein each of the defect images added in the extracted image region has different size at different positions.

17. The server of claim 12, wherein the generating the refined training data includes:
adding multiple Gaussian-blur masks or multiple white occlusion masks to arbitrary local regions within the extracted image region.

18. The server of claim 11, wherein the step (b) further includes the steps of:
(b-1) extracting a license plate region as a polygonal shape by recognizing a boundary of the license plate from the image captured by the camera;
(b-2) transforming coordinates of pixels included in the license plate region such that the polygonal shape is transformed to preset rectangular shape; and
(b-3) extracting the text information from the license plate region with transformed coordinates.

19. The server of claim 18, wherein the steps (b-1) to (b-3) are performed when the license plate region in the image captured by the camera is not in a predefined rectangular shape, or when the license plate region appears skewed due to the camera being positioned at an acute angle relative to the vehicle from above, below or sides.

20. The server of claim 11, wherein the step (e) further includes:
receiving additional identification code concerning current location from the user terminal, or receiving pre-stored location information or current GPS value from the user terminal and providing guidance information to parking location of the vehicle based on current location of the user terminal, in the exit.
